(19) United States
(12) Patent Application Publication
(10) Pub. No.: US 2011/0195687 A1
(43) Pub. Date: Aug. 11, 2011

(54) METHOD AND APPARATUS FOR COMMUNICATION OF EMERGENCY RESPONSE INSTRUCTIONS

(75) Inventors: Saumitra Mohan Das, San Jose, CA (US); Behrooz Khorashadi, San Jose, CA (US); Edward Thomas Lingham Hardie, Menlo Park, CA (US)

(73) Assignee: QUALCOMM Incorporated, San Diego, CA (US)

(21) Appl. No.: 12/703,680

(22) Filed: Feb. 10, 2010

(51) Int. Cl. H04M 11/04

(52) U.S. Cl. 455/404.2; 455/404.1

(57) ABSTRACT

The subject matter disclosed herein relates to a system and method for facilitating communication between a user of a mobile station and an emergency responder.

### BACKGROUND

1. Field:

The subject matter disclosed herein relates to communication of emergency response instructions.

2. Information:

Pedestrians within certain areas, such as within structures, may occasionally encounter emergencies. For example, some shoppers may be walking through an indoor mall when a store in the mall suddenly catches on fire or the entire mall is damaged by an earthquake, for example. In such situations, instructions can be given to the shoppers to direct the shoppers to the nearest exit.

Emergency responders may be contacted to respond to certain emergencies. For example, in the event of a fire, a fire department may be contacted to request that one or more fire trucks be sent to a particular structure which is on fire. Upon arrival at a scene of a fire, fire department personnel may attempt to extinguish the fire with fire hoses and/or assist people exiting a structure that is on fire. For example, if people within the structure are visible at a window, fire department personnel may utilize a bullhorn to shout out instructions to the people trapped inside.

### BRIEF DESCRIPTION OF THE FIGURES

Non-limiting and non-exhaustive features will be described with reference to the following figures, wherein like reference numerals refer to like parts throughout the various figures.

FIG. 1 illustrates an emergency response system according to one implementation.

FIG. 2 is a base map for a given area according to one implementation.

FIG. 3 is a map which may be provided to an emergency responder according to one implementation.

FIG. 4 is a map which may be provided to a first user of a mobile station according to one implementation.

FIG. 5 is a map which may be provided to a second user of a mobile station according to one implementation.

FIG. 6 is a map which may be provided to a third user of a mobile station according to one implementation.

FIG. 7 is a schematic diagram of an emergency responder according to one implementation.

FIG. 8 is a flow diagram illustrating a process for processing emergency response instructions received from an emergency responder according to one implementation.

FIG. 9 is a flow diagram of a process for providing emergency response instructions from an emergency responder to a mobile station according to one implementation.

FIG. 10 is a schematic block diagram of a particular implementation of a mobile station according to one implementation.

### SUMMARY

In one particular implementation, a system and method are provided for facilitating communication between a user of a mobile station and an emergency responder. A mobile station may access one or more maps for an area (e.g., a predefined area) based at least in part on an estimated location of the mobile station in response to an initiation of communication with an emergency responder by the mobile station. The mobile station may receive emergency response instructions from the emergency responder, wherein the emergency response instructions are based at least in part on the estimated location of the mobile station. It should be understood, however, that this is merely an example implementation and that claimed subject matter is not limited in this respect.

### DETAILED DESCRIPTION

Reference throughout this specification to “one example”, “one feature”, “an example” or “a feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

According to one implementation, as discussed herein, a person may utilize a mobile station to communicate with an emergency responder. For example, a person may be within a certain area when an emergency situation arises. The area may comprise a structure, such as a building, shopping mall, parking garage, or sports stadium, to name just a few among many different examples of possible structures.

An “emergency situation,” as used herein may refer to a situation, condition, and/or incident before, during or after which it is prudent to evacuate people located within a certain area. Examples of possible emergency situations include, for example, a fire burning within an area, a hostage situation where terrorists or other criminals are on the premises of the area, a gas leak, an occurrence of a natural disaster such as a tornado, earthquake, or hurricane, to name just a few among many different types of emergency situations.

If an emergency situation occurs, an emergency responder may be contacted to come to a scene of the emergency situation to help evacuate an area and/or otherwise secure the area. An “emergency responder,” as used herein, may refer to an entity, such as a person or team of people, responding to an emergency situation. For example, in the event of a fire, an emergency responder may include one or more firemen and/or policemen. An emergency responder need not be a human being in some implementations and may comprise a machine/device and/or rescue animal, for example.

A person within an area in which an emergency situation occurs may receive exit instructions. In one implementation, static instructions may be given to anyone in an area. For example, in the event of a fire in an office building, an alarm system may be activated to blink bright lights in a hallway near emergency exits and/or stairwells. Such a system may also play an audible recording instructing people to leave a building through stairwells and/or exit doors. In one system, a pre-recorded message may be played in the event of such an emergency situation. In another system, for example, a building maintenance worker may provide instructions to people on particular floors of a building by speaking into a microphone and such instructions may be broadcast through a speaker system on such floors. A drawback of such a system, however, is that in the event that a person is unfamiliar with a floor's layout or if there is a lot of smoke in the air, for example, the person may not be able to readily locate a suitable exit from a floor. Moreover, there may be obstructions preventing certain people on a floor from using a particular exit within the closest proximity, for example, but it may not be possible to inform such people of such obstructions using such an emergency system.

In one or more implementations, user-specific exit instructions and/or other information may be provided to a person having a mobile station. Such a mobile station may comprise, for example, a cell phone, Personal Digital Assistant (PDA), laptop computer, and/or another other portable device capable of transmitting and/or receiving communications. Such communications may comprise wireless communications and/or hard-wired communications such as through a telephone system or computer network. In one or more implementations, a map relating to an area in which a user is located may be accessed by and/or transmitted to the user's mobile station. For example, such a map may be presented on a display screen of a mobile station and may indicate directions for exiting a building in which a user is located, for example.

Such a mobile station may determine its location or position. In one implementation, a mobile station may estimate its location based on navigation signals received from a Satellite Positioning System (SPS), such as GPS or Galileo by, for example, correlating pseudorange measurements from several (e.g., four or more) transmitters.

However, a mobile station may be utilized within an area where navigation signals from a Satellite Positioning System (SPS) are not available, such as, for example, within certain buildings. In one implementation, a mobile station may estimate its location based on signals wirelessly received from wireless network elements or other devices capable of wirelessly transmitting signals. Wireless network elements, such as Wi-Fi access points, femtocells, etc. may be located throughout such an area at known locations and a mobile station may estimate ranges from the mobile station to particular wireless network elements (e.g., by measuring received signal strength or round-trip delay). Such ranges can be estimated, and a location of such a mobile station may be triangulated, for example.

In an emergency situation, a user of a mobile station may access an emergency responder or emergency responder system to acquire one or more maps and/or exit instructions to direct a user of the mobile station to an available exit. In one or more implementations, a user may enter or dial a designated number such as “8811” or some other predefined code, such as an alpha-numeric sequence or code, using a mobile station to access an emergency responder or emergency responder system. In one implementation, a designated number for contacting an emergency responder may be programmed into a user's mobile station or may otherwise be known to the user. In one implementation, a loudspeaker on a floor may broadcast such a designated number and request that anyone who has a mobile station dial the number to receive certain emergency response instructions. In another implementation, an access point located somewhere in a building may broadcast an emergency response number to wireless devices within a reception area. For example, a message, such as an SMS message, containing an emergency responder number may be broadcast to a user's mobile station. In one or more implementations, a user may access a particular website associated with a designated area, such as a website for a shopping mall, and one or more emergency responder numbers may be accessed from the website. Upon receiving an emergency responder number, the number may be stored within a memory of a mobile station, for example. In one or more implementations, an emergency responder may be accessible via a phone book application of a mobile station, for example. If a user dials a predefined code/number for an emergency responder or emergency responder system, the user's mobile station may access a server, for example.

A mobile station may determine its location or position via one or more techniques, such as by accessing navigations signals of an SPS system and/or by determining its location or position relative to other devices having predefined locations, such as access points or other network elements, for example. If a user's location within a certain area has been estimated by the user's mobile station, for example, such location information may be transmitted to a server. For example, a mobile station may transmit such location information by an 802.11 transmission or a phone call if a phone number for such a server is known to the mobile station. A user's mobile station may also receive a map, such as a floor plan, corresponding to a location where the user is situated. For example, a particular emergency response number dialed by a user's mobile station may correspond to a map corresponding to a particular location where a user is situated. Alternatively, a user's estimated location may be utilized to determine which map, in the event that more than one map is available, to send to a user's mobile station.

If a user's mobile station has a display capable of presenting a map, such as a Liquid Crystal Display (LCD), for example, such a map may be displayed on the mobile station. A displayed map may show a user's current location and may also display exit instructions to the user. For example, such exit instructions may display arrows or lines indicating which direction a user should move to exit an emergency. In the event, however, that a user's mobile station does not have graphical display capabilities, audible instructions may be provided to safely guide a user to an exit location. In some implementations, both visual and audible instructions may be provided to a mobile station. In some implementations, a mobile station may indicate whether it is capable of displaying a map and/or instructions by signaling a flag field, for example, in a communication to a server. For example, if a mobile station does not contain a display screen to display a map, or if such a display screen is malfunctioning, a mobile station may transmit information to an emergency responder and/or emergency responder system to indicate that the mobile station does not have visual display capabilities. In one particular example, a mobile station may include a flag and/or other indicator within a message transmitted to a location server indicating a location estimate of the mobile station. Such a flag may indicate whether visual display instructions, such as visual instructions displayed on a map should be provided to a mobile station. Another flag may also indicate, for example, whether audible instructions should be provided to a mobile station. In some implementations, both visual and audible instructions may be provided to a mobile station.

An emergency responder may also receive information about a current emergency situation. For example, one or more maps for an area in which an emergency situation is occurring may be provided to an emergency responder. In one implementation, a technician may be provided with a map of an area where a fire is occurring. Such a map may indicate all possible exits from an area. Such a map may also indicate locations where persons using mobile stations within such an area are located. An emergency responder may utilize a laptop computer, television screen, and/or any other type of device capable of displaying a map.

Additional information regarding obstructions and/or more dangerous areas of an emergency situation may also be transmitted to an emergency responder. For example, users of mobile stations within an area where an emergency situation is occurring may communicate messages to a server and/or directly to an emergency responder. For example, if a mobile station is executing an application program which displays maps of an area, a user may type a message or otherwise enter/indicate information about an emergency situation such as, for example, a specific location of a fire, obstructions and/or other dangerous areas. A user may also provide information such as a location and/or description of anyone that the user observes to be injured and/or unable to leave an area where an emergency situation is occurring. For example, emergency sensors such as fire/smoke alarms may indicate locations of fire/smoke and provide this information via a network. All such information may be provided to a server, such as a location server, and may subsequently be displayed on a map presented to an emergency responder.

A user may also be able to speak directly with an emergency responder in one implementation. For example, by entering a designated code or number, a user may speak with an emergency responder to receive exit instructions and/or to inform the emergency responder of status of an emergency situation.

A system and method as discussed herein may provide a user-friendly way to receive targeted instructions or other information from an emergency responder and/or to provide information about injuries and/or a status of an emergency situation to the emergency responder. By providing such targeted instructions, an area in which an emergency situation has occurred may be cleared of people in an efficient manner. Moreover, providing a map and/or tailored audio instructions to a user may allow an emergency responder to guide the user out of an area even if the user is unfamiliar with the area and/or locations of exits from the area.

Such as system and method as discussed herein may also provide various benefits to an emergency responder. For example, if mobile stations transmit their respective locations to a server, such locations may be displayed on a map presented to an emergency responder. By providing such location information, an emergency responder may send tailored exit instructions, for example, to mobile stations within an area. Moreover, if injury and/or emergency situation status information is also provided, such information can be utilized to determine where to send emergency responder personnel, such as firemen, for example, to aid injured people.

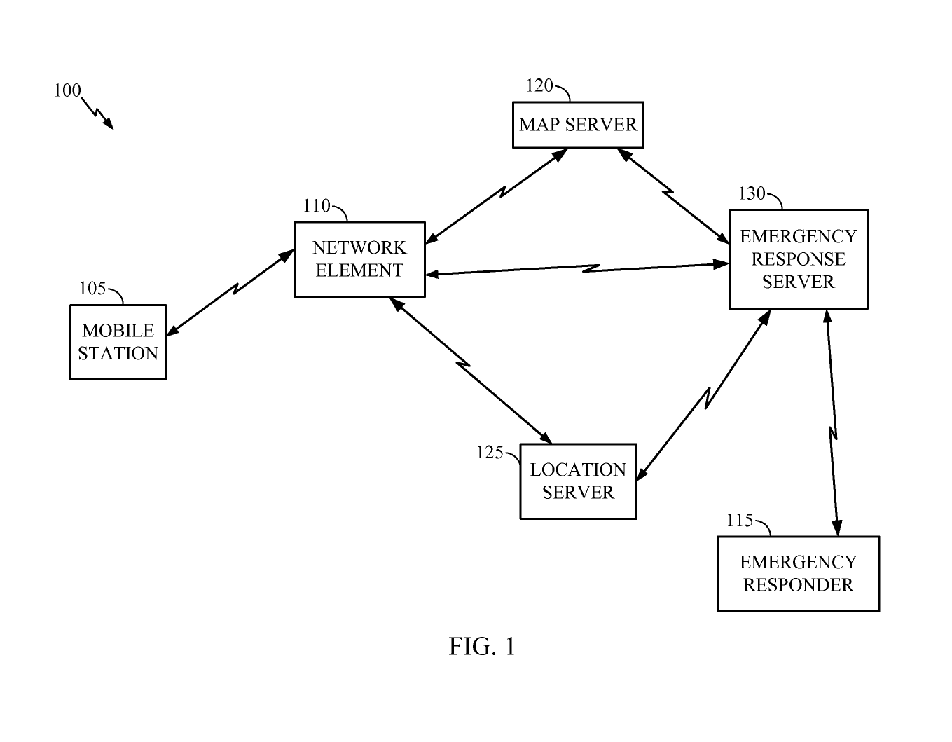

FIG. 1 illustrates an emergency response system 100 according to one implementation. In this example, a mobile station 105 is in communication with a network element 110, for example. “Network element,” as used herein, may refer to a device that allows communication devices to communicate with a network. For example, a network element may comprise a base station, access point, femtocell, etc. and may allow wireless communication devices to connect to a wireless network using Wi-Fi, Bluetooth, a cellular communication technology such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or any other suitable wireless technology and/or standard.

If a user of mobile station 105 is within a structure such as a shopping mall or office building and an emergency situation occurs, the user of mobile station 105 may initiate a communication with network element 110. A user of mobile station 105 may initiate such communication to receive emergency response instructions, such as exit instructions and/or may provide information about an emergency situation to an emergency responder 115, such as fire department personnel. A user of mobile station 105 may initiate communication with network element 110 in any one or several different ways. For example, a user may transmit entering a predefined code or number into mobile station 105 or send an email or text message, to name just a few examples. For example, a predefined code or number may be known to a user or may be stored in a memory of mobile station 105 and may be dialed and/or otherwise entered to initiate communication with network element 110. Alternatively, upon entering an area, such as a shopping mall, for example, a message may be provided to mobile station 105 to inform of a designated number or code for emergency response information for that area.

In one implementation, a mobile station may estimate its own location by communicating with one or more nearby femtocells. A “femtocell,” as used herein, may refer to a small cellular base station. Such a femtocell may connect to a service provider's network via broadband (such as, for example, via Digital Subscriber Line (DSL) or cable). A femtocell may, for example, utilize a technology such as Universal Mobile Telecommunications System (UTMS), Long Term Evolution (LTE), Evolution-Data Optimized or Evolution-Data only (EV-DO), Global System for Mobile communications (GSM), Worldwide Interoperability for Microwave Access (WiMAX), CDMA2000, or Time Division Synchronous Code Division Multiple Access (TD-SCDMA), to name just a few among many possible technologies compatible with femtocells. A femtocell may also have integrated Wi-Fi. Round-trip time ranging may be performed utilizing femtocells.

Network element 110 may be in communication with several other elements, such as a map server 120, location server 125, and an emergency response server 130. These elements may be combined in various combinations. Map server 120 may store electronic maps associated with one or more areas. For example, an owner of a particular area may upload or otherwise provide electronic maps to emergency response server 130. Such maps may indicate a floor plan of a structure including possible exits from the structure. Location server 125 may receive information from one or more mobile stations located within an area associated with one or more maps. For example, such information may include location information indicative of a location estimate for a particular mobile station. Moreover, a user of a mobile station may also provide/initiate transmission of status information (e.g., one or more signals to indicate injury status information) to location server 125. For example, a user may transmit via an SMS message or email, information indicating whether the user has sustained an injury or whether other injured people are located nearby. A user may also transmit information to indicate a current state of an emergency, such as a current location and/or size of a fire within a structure. An entity or apparatus/machine (e.g., emergency response server 130, emergency responder 115, location server 125, etc.) may process received information, such as injury status information.

Location server 125 may store information indicating estimated locations of various mobile stations/users or other status information relating to injuries and/or to a current state of an emergency situation occurring within an area. For example, mobile station 105 may transmit its estimated location and/or other status information, if it has such information, to network element 110. Network element 110 may subsequently provide such location information to location server 125. Although only one mobile station 105 is shown in FIG. 1, it should be appreciated that multiple mobile stations may communicate with network element 110 in some implementations. Accordingly, location server 125 may contain location information for different mobile stations. Location server 125 may also contain injury and/or emergency situation status information for an area. For example, a user of mobile station 105 may indicate that he/she or other people within an area are injured and/or may indicate a specific location of an emergency situation within the area. For example, a user of mobile station 105 may provide information indicating where a fire is burning within an area. Such information may be provided via a text message from mobile station 105, for example. A user of mobile station 105 may start an emergency response application running on mobile station 105. Such an emergency response application may allow a user to input injury status and/or other emergency situation information via mobile station 105.

Network element 110, map server 120, and location server 125 may be in communication with an emergency response server 130. Emergency response server 130 may transmit an electronic map for an area in which an emergency situation has occurred to emergency responder 115. Such a map may indicate a floor plan and possible exit routes. Such a map may be presented on a display device of emergency responder 115. Emergency response server 130 may also indicate respective locations of various mobile stations, injury status, and/or specific locations of an emergency situation on a map provided to emergency responder 115.

After communication with network element 110, a map for an area where mobile station 105 is located may be transmitted to or accessed by mobile station 105. For example, if mobile station 105 transmits its location to network element 110, network element 110 may determine whether a map corresponds to the location and transmit such a map to mobile station 105. A relevant map may also be transmitted to mobile station 105 based at least in part on a particular code or number dialed by a user of mobile station 105.

A map provided to mobile station 105 may indicate directions for exiting an area. For example, such directions may be provided by emergency responder 115 which may send specific instructions to a user of mobile station 105 to exit an area. Emergency responder 115 may transmit such user-specific instructions to emergency response server 130, for example. Emergency responder 115 may transmit specific instructions to emergency response server 130 via a message, such as an SMS, an email, or via a phone call in one or more implementations. Emergency response server 130 may in turn transmit such instructions through emergency response system 100 until such instructions reach mobile station 105. For example, emergency response server 130 may transmit such instructions to network element 110, which may transmit such instructions to mobile station 105. In one implementation, such instructions may include arrows or other visual indicators shown on a displayed map at mobile station 105. In one implementation, audible instructions for exiting an area or providing status or other information about an emergency situation may be provided from emergency response server 130 to network element 110 and on to mobile station 105. In one implementation, both visual indicators and audible instructions may be transmitted from emergency response server 130 to network element 110 and on to mobile station 105.

Mobile station 105 may be in direct or indirect contact (e.g., via network element 110 and emergency response server 130) with emergency responder 115. In one or more implementations, emergency responder 115 may establish a direct communication link to mobile station 105 with help from emergency response server 130. In some implementations, emergency responder 115 may update emergency response server 130 with general emergency evacuation information and mobile station 105 may access such information at emergency response server 130.

Mobile station 105 may be in constant contact with emergency response server 130 in various implementations. For example, mobile station 105 may continuously poll emergency response server 130 to check for new information or instructions. Alternatively, emergency response server 130 may “push” or send new information to mobile station 105 if emergency response server 130 is aware of a presence of mobile station 105. Such a communication link may be established through network element 110.

In one example, emergency responder 115 may generate a specific plan of action for mobile station 105 and may utilize emergency response server 130 to establish a direct communication link to mobile station 105. Emergency responder 115 may establish such a link by querying emergency response server 130 to obtain a telephone number, IP address, or other relevant contact-related information about mobile station 105 to enable establishing a link to mobile station 105, e.g., directly or through network element 110. If emergency responder 115 receives such contact-related information from emergency response server 130, emergency responder 115 may form a direct communication link with mobile station 105. Such a communication link between emergency responder 115 and mobile station 105 may be via a number of different ways, such as, for example, via a direct interface to 105, through an emergency application being executed/running on mobile station 105, or through SMS or other means as discussed. If such a communication link is established, emergency responder 115 may transmit instructions to mobile station 105 via the communication link.

In another implementation, emergency responder 115 may relay information to mobile station 105 via network element 110. For example, emergency responder 115 may transmit more generalized emergency information to a group of devices in a target location or other such groupings. In such an example, emergency responder 115 may initially issue an emergency evacuation command for a set of mobile stations (e.g., in a particular location in a building). Such an emergency evacuation command may be uploaded to emergency response server 130 which may, in turn, “push” or transmit such a command to devices with which connections have been established to network element 110, for example. A device that later establishes a connection to emergency response server 130 through network element 110 and that is also within an area associated with an emergency evacuation command may subsequently also receive such a command. For example, emergency responder 115 may issue an emergency command or instruction indicating that all users located in a west side of building A must exit through exit Y. Such a command may be uploaded to emergency response server 130 and subsequently pushed out to devices in an area associated with “west side of building A”. New devices connecting to emergency response server 130 in such a specified region may subsequently download such a command after a connection has been formed with emergency response server 130. For example, emergency responder 115 may transmit or beacon commands or information using wireless beacons with special tags. For example, emergency responder 115 may transmit commands or information using a Service Set Identifier (SSID) field to relay a message, “911: move to left hall.”

If a location estimate for mobile station 105 is not available, a general map showing several possible exits may instead be provided to mobile station 105. Alternatively, audible instructions may be provided to mobile station 105 to inform a user of several different ways of exiting an area even though a location estimate for mobile station 105 is unavailable.

An emergency response server 130 may provide one or more maps for an area associated with an emergency situation to emergency responder 115. Emergency response server 130 may also provide annotations for such a map. Such annotations may indicate locations of particular users on a map based at least in part on location estimates for mobile stations stored in location server 125. Such annotations may also include injury and/or other status information such as indications of obstructions and/or specific locations of fires or other dangerous locations within an area. Based on such a map and annotations, an emergency responder 115 may determine and provide an exit strategy/exit instructions for one or more users within an area.

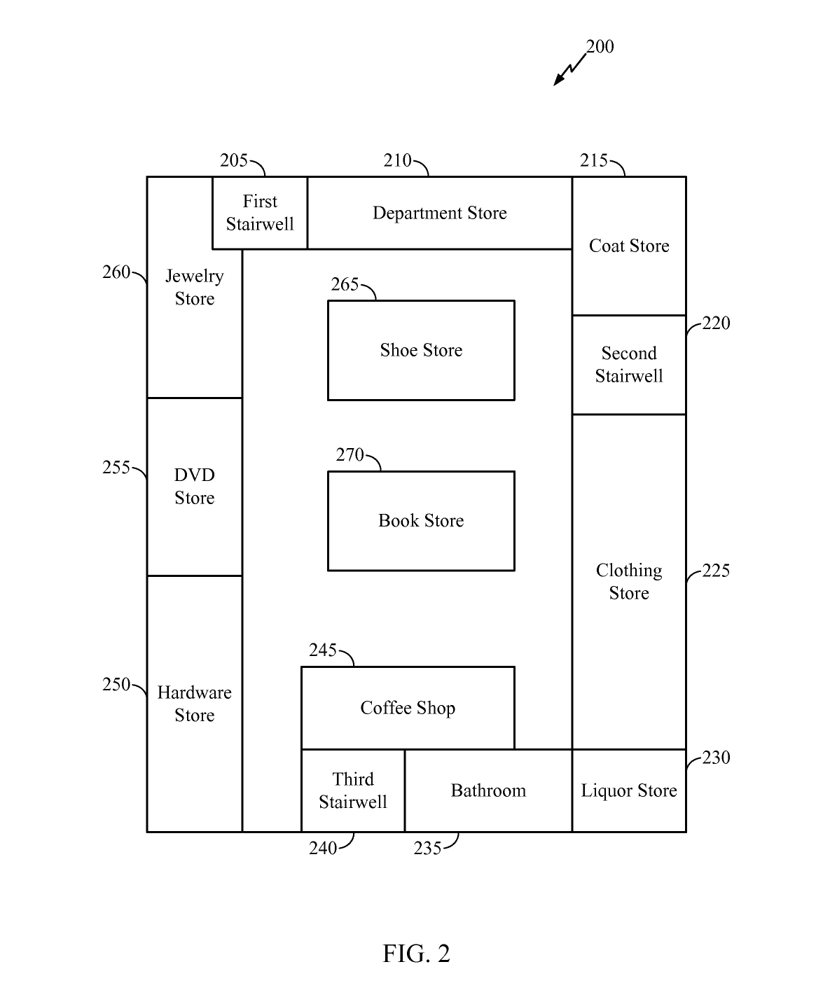

FIG. 2 is a base map 200 for a given area according to one implementation. As shown, base map 200 may include a floor plan, or a portion of a floor plan for an area. Base map 200 indicates locations of a first stairwell 205, department store 210, coat store 215, second stairwell 220, clothing store 225, liquor store 230, bathroom 235, third stairwell 240, coffee shop 245, hardware store 250, digital versatile disc (DVD) store 255, jewelry store 260, shoe store 265, and book store 270. As shown, there are at least three different exits from an area shown on base map 200—e.g., through first stairwell 205, second stairwell 220, or third stairwell 240.

As mobile stations communicate with a network to acquire emergency response information and/or transmit injury status and/or other information about an emergency situation, such information may be stored in a location server, such as location server 125 discussed above with respect to FIG. 1. A map of an area for an emergency response situation and associated annotations may be provided to an emergency responder.

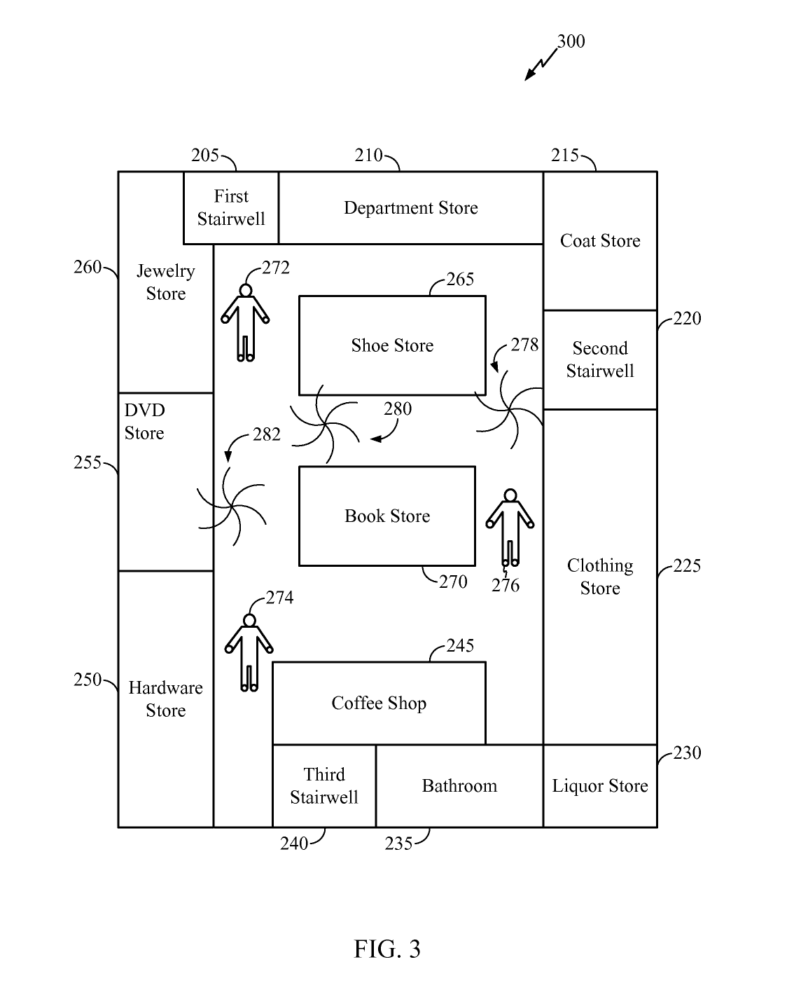

FIG. 3 is a map 300 which may be provided to an emergency responder according to one implementation. If an emergency situation occurs, map 300 may be provided to an emergency responder, such as a fire department technician, police officer, or 911/emergency operator, to name a few among many examples of emergency responders. Map 300 contains a floor plan shown in map 200 as well as certain additional annotations. As shown, map 300 may include annotations to indicate respective locations of a first user 272, second user 274, third user 276, first fire 278, second fire 280, and third fire 282. Such annotations may be utilized by an emergency responder to determine how to guide particular users out of an area corresponding to map 300. An emergency responder may guide a user to a nearest possible exit unless there is an obstruction or other impediment in the way, for example. For example, first user 272 is in close proximity to first stairwell 205 and there are no obstructions between first user 272 and first stairwell 205 shown on map 300. Third user 276, on the other hand, is in closest proximity to second stairwell 220. However, first fire 278 is located between third user 276 and second stairwell 220. Accordingly, an emergency responder may instead route third user to third stairwell 240 to exit an area shown on map 300.

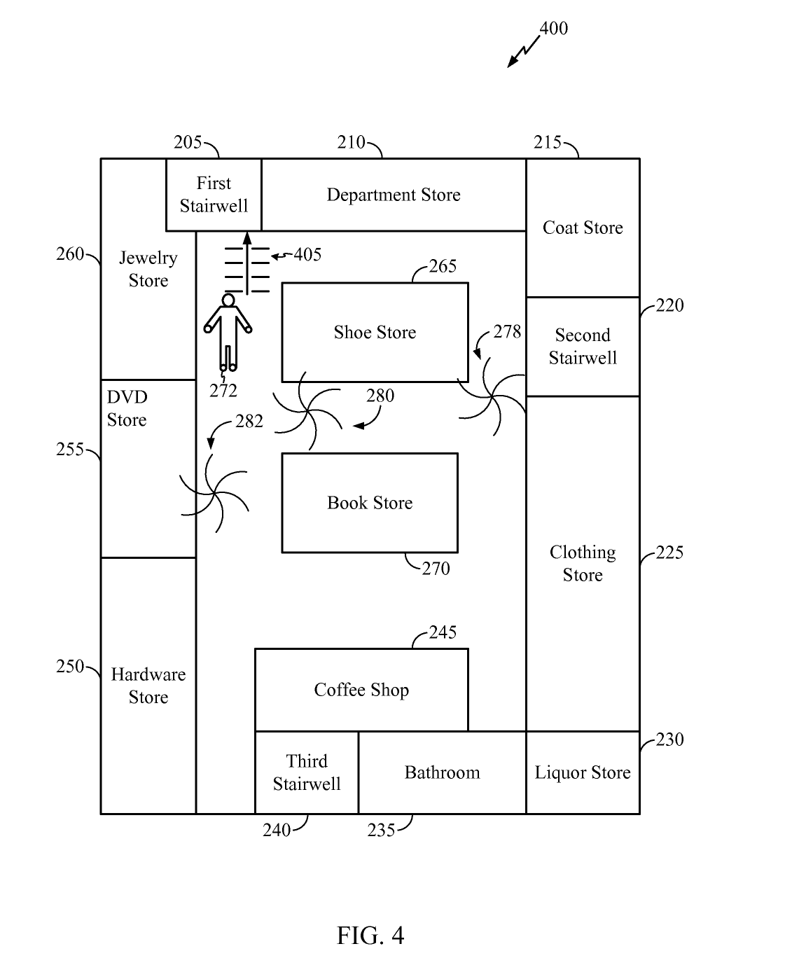

FIG. 4 is a map 400 which may be provided to a first user 272 of a mobile station according to one implementation. Map 400 may contain instructions to guide first user 272 safely out of an area depicted by map 400. In this example, an emergency responder may determine that first user 272 should leave an area via first stairwell 205. Accordingly, a big arrow 405 may be shown to guide first user 272 to first stairwell 205. For example, arrow 405 may be displayed with a color different from that of a background of map 400 to make it easier to see and/or may be shown with flashing pixels/lights on a display screen of a user's mobile station. Alternatively, as discussed above, audible exit instructions may be provided to guide first user 272 to first stairwell 205. Although map 400 shows a floor plan of the entire floor, it should be appreciated that in some implementations, only a portion of a floor or area may be displayed on map 400. In one implementation, first user's 272 location on map 400 may be periodically updated to account for movement of first user 272 through an area depicted by map 400. Map 400 displays first fire 278, second fire 280, and third fire 282, but not any other users, such as second user 274 or third user 276 shown in map 300 of FIG. 3. In some implementations, locations of other users may be shown on map 400.

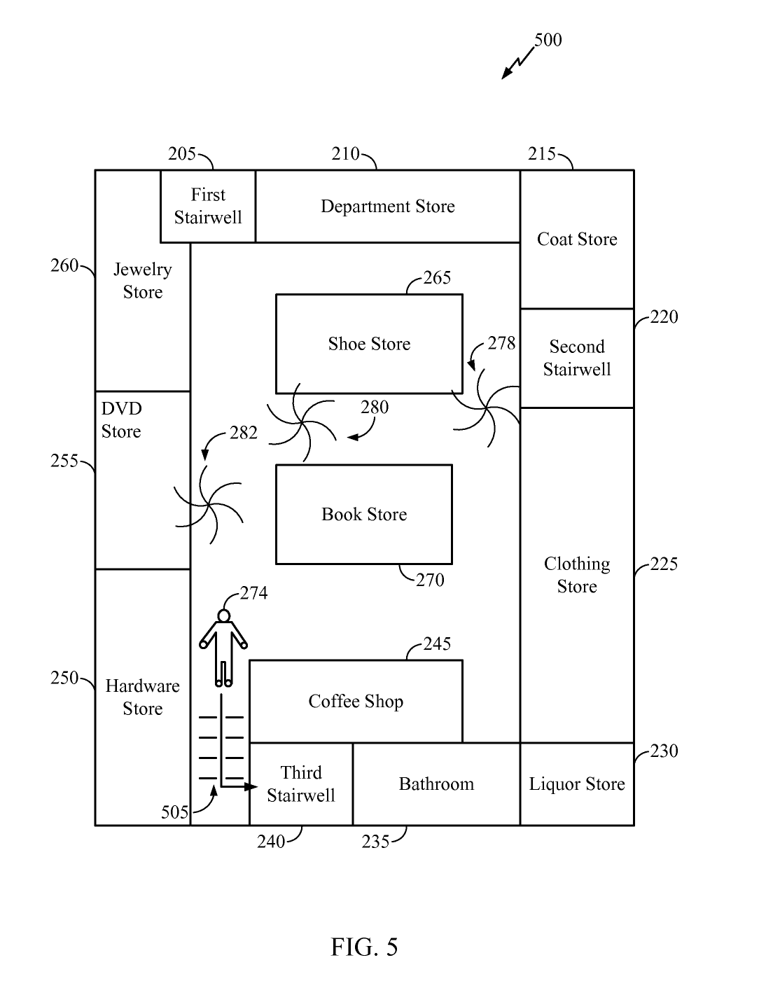

FIG. 5 is a map 500 which may be provided to a second user 274 of a mobile station according to one implementation. Map 500 may contain instructions to guide second user 274 safely out of an area depicted by map 500. In this example, an emergency responder may determine that second user 274 should leave an area via third stairwell 240. Accordingly, a big arrow 505 may be shown to guide second user 274 to third stairwell 240. For example, arrow 505 may be displayed with a different color than a background of map 500 to make it easier to see and/or may be shown with a flashing light. Alternatively, as discussed above, audible exit instructions may be provided to guide second user 274 to third stairwell 240. Although map 500 shows a floor plan of the entire floor, it should be appreciated that in some implementations, only a portion of a floor or area may be displayed on map 500. In one implementation, a location of a second user 274 on map 500 may be periodically updated to account for movement of second user 274 through an area depicted by map 500.

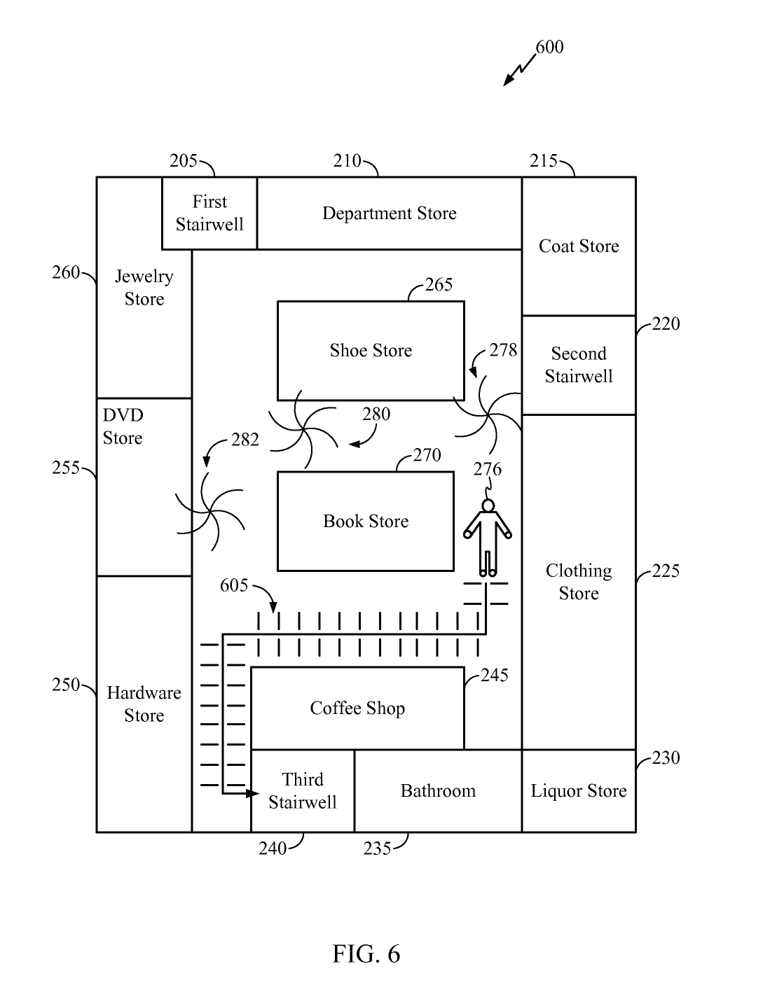

FIG. 6 is a map 600 which may be provided to a third user 276 of a mobile station according to one implementation. Map 600 may contain instructions to guide third user 276 safely out of an area depicted by map 600. In this example, third user 276 is in closest proximity to second stairwell 220. However, first fire 278 is disposed between third user 276 and second stairwell 220. Accordingly, an emergency responder may instead direct third user 276 to leave via third stairwell 240. A big arrow 605 may be shown to guide third user 276 to third stairwell 240. For example, arrow 605 may be displayed with a different color than a background of map 600 to make it easier to see and/or may be shown with a flashing light. Alternatively, as discussed above, audible exit instructions may be provided to guide third user 276 to third stairwell 240. Although map 600 shows a floor plan of the entire floor, it should be appreciated that in some implementations, only a portion of a floor or area may be displayed on map 600. In one implementation, third user's 276 location on map 600 may be periodically updated to account for movement of third user 276 through an area depicted by map 600.

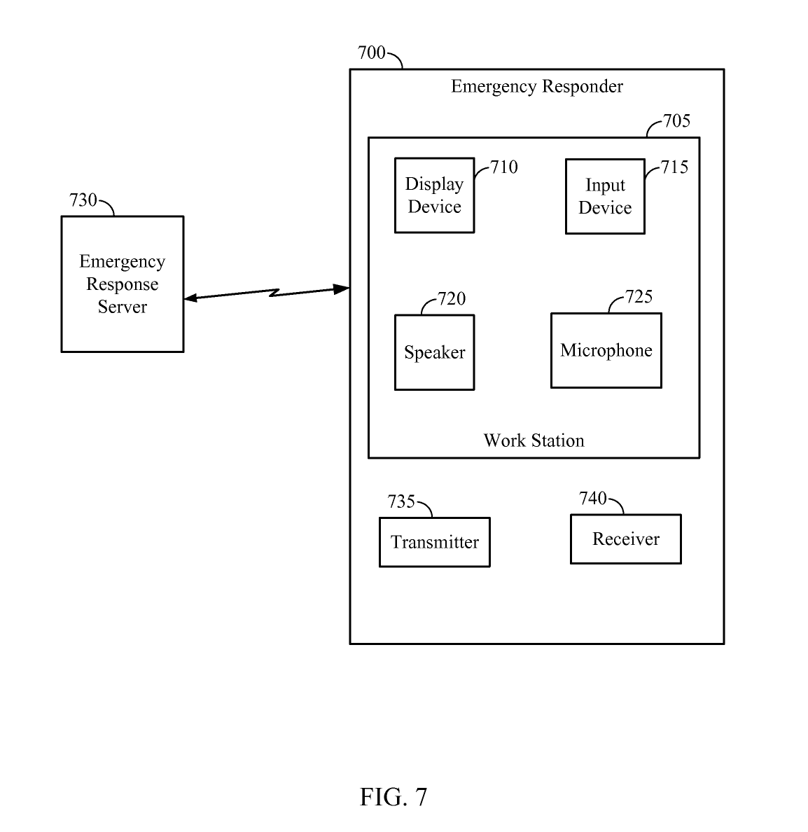

FIG. 7 is a schematic diagram of an emergency responder 700 according to one implementation. In this example, emergency responder 700 may comprise a workstation 705 having items such as a display device 710, input device 715, speaker 720, and microphone 725, to name just a few among many examples. Display device 710 may display a map of an area where an emergency situation is occurring. A person, such as a fireman or police officer, for example, may provide instructions for a user via input device 715. Input device 715 may include various elements for receiving user input such as, for example, a keyboard, mouse, trackball, touchpad, or touch screen, to name just a few possible examples of input devices. Instead of a person inputting instructions, instructions may also be given by a machine/device. Speaker 720 and microphone 725 may be utilized to provide audible instructions and/or to conduct an audible conversation with a user within an area. Emergency responder 700 may communicate with an emergency response server 730, which may in turn transmit messages to and/or receive messages from a mobile station of a user within an area undergoing an emergency situation.

Emergency responder 700 may include a transmitter 735 to transmit user-specific instructions to a user of a mobile station to direct the user out of an area. Emergency responder 700 may also include a receiver 740 for receiving one or more signals from one or more mobile stations. For example, such signals may be indirectly received from one or more mobile stations. In one or more implementations, such signals may be transmitted from a mobile station to emergency response server 730 and then from emergency response server 730 to receiver 740 of emergency responder 700.

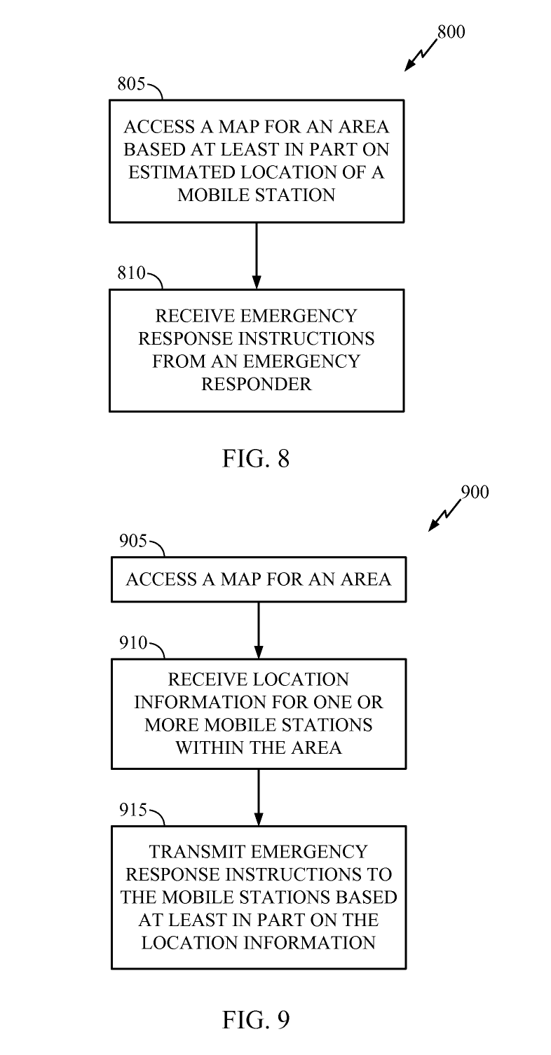

FIG. 8 is a flow diagram illustrating a process 800 for processing emergency response instructions received from an emergency responder according to one implementation. First, a mobile station may access one or more maps for a predefined area at operation 805. Such maps may be accessed based at least in part on an estimated location of the mobile station in response to an initiation of communication with an emergency responder by the mobile station. At operation 810, emergency response instructions may be received from an emergency responder based at least in part on an estimated location of the mobile station.

FIG. 9 is a flow diagram illustrating a process 900 for providing emergency response instructions from an emergency responder to a mobile station according to one implementation. At operation 905, one or more maps for a predefined area may be retrieved, received, or otherwise accessed from a database or location server by an emergency responder. Next, at operation 910, location information for one or more mobile stations located within the predefined area may be transmitted from a database or location server to an emergency responder, for example. Such location information may be displayed on a graphical map or presented as coordinates on a map so that an emergency responder may recognize where people are located within a building or structure, for example. Based on such location information, an emergency responder may determine how to guide or direct people to an exit from such a building or structure, for example. Finally, at operation 915, emergency response instructions may be transmitted from an emergency responder to an emergency response server or location server, for example. Such emergency response instructions may be transmitted to one or more mobile stations for any users within a building or structure. Such emergency response instructions may be presented on a display device of the one or more mobile stations.

Circuitry, such as transmitters and/or receivers may provide functionality, for example, through the use of various wireless communication networks such as a wireless wide area network (WWAN), a wireless local area network (WLAN), a wireless personal area network (WPAN), and so on. The terms “network” and “system” are often used interchangeably. The terms “location” and “position” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Communications (GSM), Digital Advanced Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.1 1x network, and a WPAN may be a Bluetooth network, an IEEE 802.15x, or some other type of network. The techniques may also be used for any combination of WWAN, WLAN and/or WPAN. The techniques may be implemented for use with an Ultra Mobile Broadband (UMB) network, a High Rate Packet Data (HRPD) network, a CDMA2000 1x network, GSM, Long-Term Evolution (LTE), and/or the like.

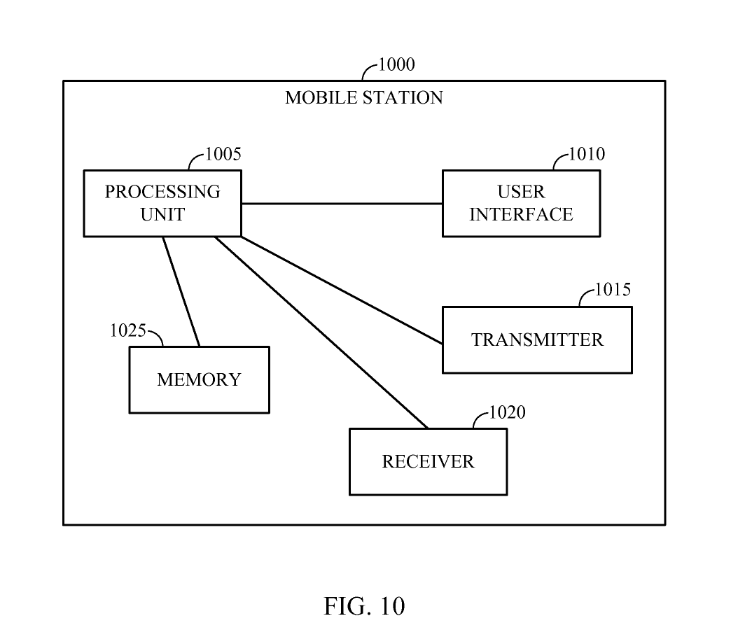

FIG. 10 is a schematic block diagram of a particular implementation of a mobile station 1000 according to one implementation. Mobile station 1000 may comprise a mobile station, for example, in which a radio transmitter may be adapted to modulate an RF carrier signal with baseband information, such as voice or data, onto an RF carrier, and a radio receiver may demodulate a modulated RF carrier to obtain such baseband information. As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Mobile station 1000 may include several elements such as a processing unit 1005, user interface 1010, transmitter 1015, receiver 1020, and memory 1025. User interface 1010 may comprise a plurality of devices for inputting or outputting user information such as voice or data. Such devices may include, for example, a keyboard/keypad, a display screen (e.g., a touch screen), a microphone, a speaker, buttons/knobs/dials, just to name a few examples. User interface 1010 may present a map to a user.

Memory 1025 may be adapted to store machine-readable instructions, which are executable to perform one or more of processes, examples, or implementations thereof which are described or suggested. Processing unit 1005 may be adapted to access and execute such machine-readable instructions. Through execution of these machine-readable instructions, processing unit 1005 may direct various elements of mobile station 1000 to perform one or more functions.

Transmitter 1015 may utilize an antenna to transmit communications, such as packet-based communications to other wireless devices. Receiver 1020 may also utilize such an antenna to receive communications, such as packet-based communications from other wireless devices.

Some portions of the detailed description above are presented in terms of algorithms or symbolic representations of operations on binary digital signals stored within memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. For example, a specific computing apparatus may comprise one or more processing units programmed with instructions to perform one or more specific functions.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, techniques are not restricted to global systems (e.g., GNSS) for SPS. For example, techniques may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System P (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices designed to perform the functions described herein, and/or combinations thereof.

For firmware and/or software implementations, certain methodologies may be implemented with modules (e.g., procedures, functions, and so on) that perform the functions described herein. Any machine readable medium tangibly embodying instructions may be used in implementing the methodologies described herein. For example, software codes may be stored in a memory of a mobile station, an access point, a femtocell, etc. and executed by a processing unit of the device. Memory may be implemented within a processing unit and/or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. A computer-readable medium may take the form of an article of manufacture. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by the processing unit. Again, these are merely examples of an instruction and claimed subject matter is not limited in this respect.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method, comprising:
accessing, by a mobile station, one or more maps for an area based at least in part on an estimated location of the mobile station in response to an initiation of communication with an emergency responder by the mobile station; and
receiving emergency response instructions from the emergency responder, wherein the emergency response instructions are based at least in part on the estimated location of the mobile station.

2. The method of claim 1, further comprising presenting the one or more maps on a display device of the mobile station.

3. The method of claim 1, further comprising presenting the emergency response instructions on a display device of the mobile station.

4. The method of claim 1, further comprising initiating the communication with the emergency responder in response to dialing a predefined alpha-numeric sequence.

5. The method of claim 1, further comprising providing injury status information to the emergency responder based at least in part on a user input.

6. The method of claim 1, wherein the emergency responder comprises a fire department technician, a police officer, or an emergency operator.

7. The method of claim 1, further comprising determining the estimated location of the mobile station.

8. The method of claim 1, wherein the one or more maps are accessed via communication with a femtocell.

9. An apparatus, comprising:
a transmitter;
a receiver; and
a processing unit to direct the transmitter to initiate transmission of one or more signals to an emergency responder in response to the receiver receiving:
one or more maps for an area based at least in part on an estimated location of the apparatus in response to an initiation of communication with an emergency responder by the apparatus, and
emergency response instructions from an emergency responder, wherein the emergency response instructions are based at least in part on the estimated location of the apparatus.

10. The apparatus of claim 9, further comprising a display device to present the one or more maps.

11. The apparatus of claim 10, wherein the display device is capable of presenting the emergency response instructions.

12. The apparatus of claim 9, wherein the apparatus is capable of initiating the communication with the emergency responder in response to a dialing of a predefined alpha-numeric sequence.

13. The apparatus of claim 9, wherein the processing unit is capable of directing the transmitter to initiate the transmission of the one or more signals to indicate injury status information to the emergency responder based at least in part on a user input.

14. The apparatus of claim 9, wherein the emergency responder comprises a fire department technician, a police officer, or an emergency operator.

15. The apparatus of claim 9, wherein the apparatus is capable of estimating the location of the apparatus.

16. The apparatus of claim 9, wherein the one or more maps are received via a communication with a femtocell.

17. An apparatus, comprising:
means for processing one or more maps for an area based at least in part on an estimated location of the apparatus in response to an initiation of communication with an emergency responder by the apparatus, and for receiving emergency response instructions from an emergency responder based at least in part on the estimated location of the apparatus; and
means for initiating transmission of one or more signals to the emergency responder.

18. The apparatus of claim 17, further comprising means for displaying the one or more maps.

19. The apparatus of claim 18, wherein the means for displaying is capable of displaying the emergency response instructions.

20. The apparatus of claim 17, further comprising means for initiating the communication with the emergency responder in response to a dialing of a predefined alpha-numeric sequence.

21. The apparatus of claim 17, further comprising means for providing injury status information to the emergency responder in response to a user input.

22. The apparatus of claim 17, wherein the emergency responder comprises a fire department technician, a police officer, or an emergency operator.

23. The apparatus of claim 17, further comprising location estimation means for estimating the location of the apparatus.

24. The apparatus of claim 17, wherein the one or more maps are received via a communication with a femtocell.

25. An article, comprising:
a storage medium comprising machine-readable instructions executable by a special purpose apparatus to:
access one or more maps for an area based on an estimated location of a mobile station in response to the mobile station initiating communication with an emergency responder; and
process emergency response instructions received from the emergency responder based at least in part on the estimated location for the mobile station.

26. The article of claim 25, wherein the machine-readable instructions are further executable by the special purpose apparatus to present the one or more maps on a display device of the mobile station.

27. The article of claim 25, wherein the machine-readable instructions are further executable by the special purpose apparatus to present the emergency response instructions on a display device of the mobile station.

28. The article of claim 25, wherein the machine-readable instructions are further executable by the special purpose apparatus to initiate the communication with the emergency responder in response to a predefined alpha-numeric sequence being dialed via the mobile station.

29. The article of claim 25, wherein the machine-readable instructions are further executable by the special purpose apparatus to provide injury status information to the emergency responder in response to a user input.

30. The article of claim 25, wherein the machine-readable instructions are further executable by the special purpose apparatus to estimate the location of the mobile station.

31. The article of claim 25, wherein the one or more maps are received via a communication with a femtocell.

32. A method, comprising:
accessing one or more maps for an area;
receiving location information for one or more mobile stations located within the area;
determining user-specific emergency response instructions for the one or more mobile stations based at least in part on the location information for the one or more mobile stations; and
transmitting the user-specific emergency response instructions to the one or more mobile stations.

33. The method of claim 32, wherein the area comprises one or more structures.

34. The method of claim 33, wherein the one or more maps indicate one or more floor plans for the one or more structures.

35. The method of claim 32, wherein the emergency response instructions comprise exit information for one or more users of the one or more mobile stations to exit the area.

36. The method of claim 32, further comprising receiving injury status information from at least one of the one or more mobile stations.

37. The method of claim 32, further comprising presenting on a display device the one or more maps and respective locations of the one or more mobile stations on the one or more maps.

38. An apparatus, comprising:
a transmitter;
a receiver capable of receiving one or more signals from one or more mobile stations; and
a processing unit to initiate transmission of user-specific emergency response instructions through the transmitter to the one or more mobile stations, the emergency response instructions being based at least in part on location information for the one or more mobile stations, and to access one or more maps for an area including locations of the one or more mobile stations.

39. The apparatus of claim 38, wherein the one or more maps are accessed from a map server.

40. The apparatus of claim 38, wherein the area comprises one or more structures.

41. The apparatus of claim 40, wherein the one or more maps indicate one or more floor plans for the one or more structures.

42. The apparatus of claim 38, wherein the emergency response instructions comprise exit information for one or more users of the one or more mobile stations to exit the area.

43. The apparatus of claim 38, wherein the one or more signals received from the one or more mobile stations comprise injury status information.

44. The apparatus of claim 38, further comprising a display device to present the one or more maps and respective locations of the one or more mobile stations.

45. An apparatus, comprising:
means for receiving one or more signals from one or more mobile stations located within an area;
means for initiating transmission of user-specific emergency response instructions to the one or more mobile stations based at least in part on location information for the one or more mobile stations; and
means for accessing one or more maps for the area.

46. The apparatus of claim 45, wherein the one or more maps are accessed from a map server.

47. The apparatus of claim 45, wherein the area comprises one or more structures.

48. The apparatus of claim 47, wherein the one or more maps indicate one or more floor plans for the one or more structures.

49. The apparatus of claim 45, wherein the emergency response instructions comprise exit information for one or more users of the one or more mobile stations to exit the area.

50. The apparatus of claim 45, wherein the one or more signals received from the one or more mobile stations comprise injury status information.

51. The apparatus of claim 45, further comprising means for displaying the one or more maps and respective locations of the one or more mobile stations.

52. An article, comprising:
a storage medium comprising machine-readable instructions executable by a special purpose apparatus to:
access one or more maps for an area;
process location information for one or more mobile stations located within the area;
determine user-specific emergency response instructions for the one or more mobile stations based at least in part on the location information for the one or more mobile stations; and
transmit the user-specific emergency response instructions to the one or more mobile stations.

53. The article of claim 52, wherein the machine-readable instructions are further executable by the special purpose apparatus to present the one or more maps and respective locations of the one or more mobile stations on a display device.

54. The article of claim 52, wherein the area comprises one or more structures.

55. The article of claim 54, wherein the one or more maps indicate one or more floor plans for the one or more structures.

56. The article of claim 52, wherein the emergency response instructions comprise exit information for one or more users of the one or more mobile stations to exit the area.

57. The article of claim 52, wherein the machine-readable instructions are further executable by the special purpose apparatus to process injury status information received from at least one of the one or more mobile stations.
